(19) United States
(12) Patent Application Publication
(10) Pub. No.: US 2015/0155557 A1
(43) Pub. Date: Jun. 4, 2015

(54) NEGATIVE ELECTRODE ACTIVE MATERIAL FOR RECHARGEABLE LITHIUM BATTERY, METHOD FOR PREPARING THE SAME AND RECHARGEABLE LITHIUM BATTERY USING THE SAME

(71) Applicant: POSCO CHEMTECH CO., LTD., Pohang-si (KR)

(72) Inventors: Se Mann KWON, Seoul (KR); Yong Tae Park, Sejong-si (KR)

(73) Assignee: POSCO CHEMTECH CO., LTD., Pohang-si (KR)

(21) Appl. No.: 14/275,922

(22) Filed: May 13, 2014

(30) Foreign Application Priority Data
Dec. 4, 2013 (KR) 10-2013-0150098

(51) Int. Cl. H01M 4/587; C01B 31/04

(52) U.S. Cl. CPC H01M 4/587; C01B 31/04

(57) ABSTRACT

The present invention relates to a negative electrode active material for a rechargeable lithium battery, a method for preparing the same, and a rechargeable lithium battery using the same. This invention provides a negative electrode active material for a rechargeable lithium battery, comprising a highly crystalline spherical natural graphite, wherein a Raman R value is 0.03 or more and 0.15 or less, and an internal porosity (ml/g) is 0.15 or less.

The Raman R value means that the intensity ratio R (R=Id/Ig) measured by the intensity Ig of peak Pg near the 1580 cm⁻¹ and the intensity Id of peak Pd near the 1360 cm⁻¹ in the Raman spectrum analysis.

### CROSS-REFERENCE TO RELATED APPLICATION

This application claims priority to and the benefit of Korean Patent Application No. 10-2013-0150098 filed in the Korean Intellectual Property Office on December 04, 2013, the entire contents of which are incorporated herein by reference.

### BACKGROUND OF THE INVENTION

(a) Field of the Invention

The following disclosure relates to a negative electrode active material for a rechargeable lithium battery, a method for preparing the same, and a rechargeable lithium battery using the same.

(b) Description of the Related Art

As a negative electrode active material for the rechargeable lithium battery, a carbon-based material is mainly used. Formerly, as a negative electrode active material for the rechargeable lithium battery, crystalline carbon materials including artificial graphite, natural graphite capable of intercalating and de-intercalating lithium have been used. The graphite has a low discharge voltage of −0.2 V compared to lithium, thus provides an advantage in terms of energy density of a lithium battery because a battery using graphite as a negative active material represents a high discharge voltage of 3.6 V. Moreover, the graphite has been widely used due to its excellent reversibility to improve cycle-life of the rechargeable lithium battery.

In case of natural graphite, it has a high efficiency as a negative electrode active material because of its low price and a similar electrochemical characteristic to the artificial graphite. However, the natural graphite has a large surface area and a completely exposed edge surface due to its plate-like shape. Thus, when it applies to a negative electrode active material, a reaction of penetration or decomposition of electrolyte can takes place. As a result, the edge surface is peeled off or destroyed, so finally a non-reversible reaction significantly takes place. In addition, when it is produced by electrode plate, the graphite active material is flatly pressed and oriented on a current collector, so impregnation of the electrolyte solution is not easy and charge-discharge characteristics may be deteriorated.

Therefore, the natural graphite is converted to a smooth form of the surface shape through a post-treatment process such as transforming into spherical shape to reduce the irreversible reaction and to improve the processability of the electrode. Moreover, by coating the low crystalline carbon such as pitch through heat-treatment the edge surface of the graphite can be prevented from being exposed and protected the destruction caused by the electrolyte and also reduced the irreversible reaction. A method of preparing a negative electrode active material by coating a low crystalline carbon to spherical natural graphite is the common way in most manufacturers of negative materials.

However, the negative electrode active material made by the method stated above has a problem that the negative electrode active material on the current collector is easily deteriorate by repeated volume expansion and contraction in the course of a lithium insertion and desorption. As a result, the increase in the non-reversible capacity causes a deterioration of the cycle-life characteristics and increase in volume. Therefore, development of the negative electrode active material having suppressed volume expansion and non-deteriorated cycle-life characteristics during product life period is needed.

### SUMMARY OF THE INVENTION

The present invention relates to a negative electrode active material for a rechargeable lithium battery, a method for preparing the same, and a rechargeable lithium battery using the same. More particularly, the present invention relates to a negative active material for a rechargeable lithium battery which is made by high-densely isotropically compressing a spherical natural graphite having a controlled crystal structure, a method for preparing the same, and a rechargeable lithium battery using the same.

An exemplary embodiment of the present invention provides a negative electrode active material for a rechargeable lithium battery, comprising a highly crystalline spherical natural graphite, wherein a Raman R value is 0.03 or more and 0.15 or less, and an internal porosity (ml/g) is 0.15 or less. More particularly, the internal porosity may be 0.15 or less which is an internal porosity of a particle size 2 μm or less.

The Raman R value means that the intensity ratio R (R=Id/Ig) measured by the intensity Ig of peak Pg near the 1580 cm⁻¹ and the intensity Id of peak Pd near the 1360 cm⁻¹ in the Raman spectrum analysis.

The highly crystalline spherical natural graphite may be an oxidized form of the spherical natural graphite.

The highly crystalline spherical natural graphite may be a form reduced internal pore by an isostatic press.

A tap density (g/cm³) of the highly crystalline spherical natural graphite may be 1.0 or more and 1.5 or less.

An average particle size of the highly crystalline spherical natural graphite may be 5 to 30 μm.

Another exemplary embodiment of the present invention provides a method for preparing a negative electrode active material for a rechargeable lithium battery, comprising preparing a natural graphite; obtaining a highly crystalline natural graphite by heat treatment of the natural graphite; densifying the highly crystalline natural graphite by an isostatic press; grinding the densified highly crystalline natural graphite.

The obtaining a highly crystalline natural graphite by heat treatment of the natural graphite may be performed at a temperature of 400 to 700° C.

The obtaining a highly crystalline natural graphite by heat treatment of the natural graphite may be performed in an oxidizing condition of a gas or solid phase including an oxygen or a material capable of oxidation of graphite.

The densifying the highly crystalline natural graphite by an isostatic press may be performed at a pressure 50 MPa or more.

A Raman R value of the prepared negative electrode active material may be 0.03 or more and 0.15 or less, and an internal porosity (ml/g) of the prepared material may be 0.15 or less.

The Raman R value means that the intensity ratio R(R=Id/Ig) measured by the intensity Ig of peak Pg near the 1580 cm⁻¹ and the intensity Id of peak Pd near the 1360 cm⁻¹ in the Raman spectrum analysis.

A tap density (g/cm³) of the prepared negative electrode active material may be 1.0 or more and 1.5 or less.

An average particle size of the prepared negative electrode active material may be 5 to 30 μm.

Yet another exemplary embodiment of the present invention provides a rechargeable lithium battery comprising: a negative electrode containing the negative electrode active material for a rechargeable lithium battery of the above exemplary embodiment of the present invention; a positive electrode; and an electrolyte.

A negative electrode active material having high tap density characteristics by high-densily particlization of a spherical natural graphite having a controlled crystal structure and long cycle-life characteristics by suppression of volume expansion may be provided.

### BRIEF DESCRIPTION OF THE DRAWINGS

FIG. 1 is an exploded perspective view of a rechargeable lithium battery according to an exemplary embodiment of the present invention.

### DETAILED DESCRIPTION OF THE EMBODIMENTS

Hereinafter, embodiments of the present invention will be described in detail. However, the embodiments are described for illustrative purpose, and the present invention is not limited thereto. Therefore, the present invention will be defined by the scope of the appended claims to be described below.

A requirement for a long cycle-life characteristic of rechargeable lithium battery is increased due to a universalization of a product requiring lithium battery's long-term use such as smart phones or electric vehicles. Moreover, in case of the battery whose appearance is consisted of aluminum pouch cell, such as the polymer battery which is one of the rechargeable lithium battery, a suppression of volume expansion during its cycle life is one of the most important factors.

However, a graphite which is the main component of the rechargeable lithium battery has some problems with deterioration of cycle-life and increase in its volume, due to various reasons such as the weak bonding between graphite particles caused by repeated contractions of the lithium's swelling and de-intercalation in the course of a lithium intercalation, and the volume expansion due to the growth of SEI (Solid Electrolyte Interphase) in graphite surface and internal pore.

In detail, since a natural graphite is plate crystal and it has a high orientation, it is difficult to apply to a battery due to an output deteriorated on electrode plates. Thus, in general, a natural graphite is prepared from a negative electrode active material for a rechargeable lithium battery by transforming into spherical shape.

However, the processing of transforming a natural graphite into spherical shape causes a defect in crystal structure and an internal pore. As a result, the performance of battery may be deteriorated by the defect in the crystal structure and by a side reaction with electrolyte.

To overcome these problems, the present inventors have developed an improved negative electrode active material for a rechargeable lithium battery by removing a defective portion of a crystal structure of spherical natural graphite through oxidization and by densifying (decreasing an internal pore) through an isostatic press (CIP or HIP).

In detail, an exemplary embodiment of the present invention provides a negative electrode active material for a rechargeable lithium battery, comprising: a highly crystalline spherical natural graphite, wherein a Raman R value is 0.03 or more and 0.15 or less, and an internal porosity (ml/g) is 0.15 or less.

The Raman R value means that the intensity ratio R (R=Id/Ig) measured by the intensity Ig of peak Pg near the 1580 cm⁻¹ and the intensity Id of peak Pd near the 1360 cm⁻¹ in the Raman spectrum analysis.

The highly crystalline spherical natural graphite may be an oxidized form of the spherical natural graphite.

In detail, the spherical natural graphite removed a defective portion of its crystal structure may be prepared by oxidation at a temperature of 400 to 700° C. Such a preparing method will be described below in more detail. In this specification, a natural graphite prepared by the method stated above is named a highly crystalline natural graphite.

The highly crystalline spherical natural graphite may be a form reduced internal pore through an isostatic press.

In more detail, a high-density graphite molded body can be obtained by pressing the prepared highly crystalline natural graphite for 1 minute or more to 100 MPa through an isostatic press (e.g., Cold Isostatic Press, CIP equipment). The pressure is about 50 MPa to 200 MPa, but there is no limitation for the upper limit on the pressure. More specific preparing method will be described below. Thereafter, a high-density and highly crystalline spherical natural graphite can be obtained by classification using 45 μm network after deagglomeration of the molded body through a Pin Mill.

A tap density (g/cm³) of the highly crystalline spherical natural graphite may be 1.0 or more and 1.5 or less. Such the high tap density make preparing a high-density pole plate easier and it also produces improvements in solution injection of electrolyte and in volume expansion of the battery's cycle life.

An average particle size of the highly crystalline spherical natural graphite may be 5 to 30 μm. It can be classified according to the purposed size, but is not limited thereto.

Another exemplary embodiment of the present invention provides a method for preparing a negative electrode active material for a rechargeable lithium battery, comprising preparing a natural graphite; obtaining a highly crystalline natural graphite by heat-treatment of the natural graphite; densifying the highly crystalline natural graphite by an isostatic press; grinding the densified highly crystalline natural graphite.

The obtaining a highly crystalline natural graphite by heat-treatment of the natural graphite may be performed at a temperature of 400 to 700° C. In the course of working through these steps, a particle of the natural graphite can be highly crystallized. Since a description of the highly crystallized graphite particle is the same as previously stated above, the description thereof will be omitted.

The obtaining a highly crystalline natural graphite by heat treatment of the natural graphite may be performed in an oxidizing condition of a gas or solid phase including an oxygen or a material capable of oxidation of graphite.

The densifying the highly crystalline natural graphite by an isostatic press may be performed at a pressure 50 MPa or more. In detail, a high-density graphite molded body can be obtained by pressing the prepared highly crystalline natural graphite for 1 minute or more to 100 MPa through an isostatic press (e.g., Cold Isostatic Press, CIP equipment). The pressure is about 50 MPa to 200 MPa, but there is no limitation for the upper limit on the pressure.

A Raman R value of the prepared negative electrode active material may be 0.03 or more and 0.15 or less and its internal porosity (ml/g) may be 0.15 or less. Since a description of this is the same as previously mentioned above, its description thereof will be omitted.

The Raman R value means that the intensity ratio R (R=Id/Ig) measured by the intensity Ig of peak Pg near the 1580 cm⁻¹ and the intensity Id of peak Pd near the 1360 cm⁻¹ in the Raman spectrum analysis.

A tap density of the prepared negative electrode active material may be 1.0 or more and 1.5 or less. An average particle size of the prepared negative electrode active material may be 5 to 30 μm.

Yet another exemplary embodiment of the present invention provides a rechargeable lithium battery, comprising: a negative electrode containing a negative electrode active material prepared according to the preparing method of the negative active material for a rechargeable lithium battery; a positive electrode containing a positive electrode active material; alternatively, a separator existing between the negative electrode and the positive electrode; and an electrolyte.

The rechargeable lithium battery may be classified into a lithium ion battery, a lithium ion polymer battery, and a lithium polymer battery according to a kind of the electrolyte and the separator used therein, it may have a cylindrical shape, a square shape, a coin shape, a pouch shape, or the like, and it may be a bulk type or a thin film type according to a size. Since the structure of the battery and the method for preparing the same are well known in the art, the detailed description thereof will be omitted.

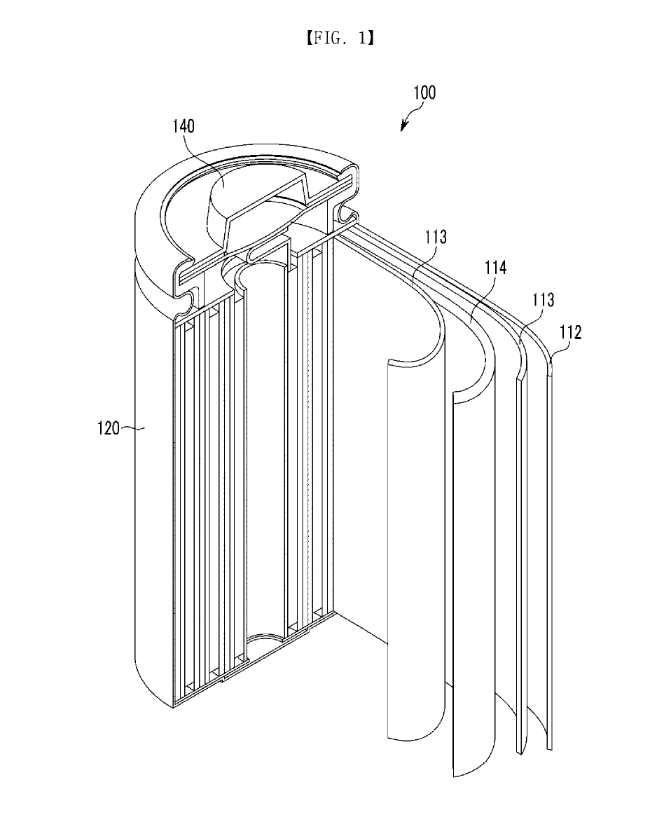

FIG. 1 is an exploded perspective view of a rechargeable lithium battery according to an exemplary embodiment of the present invention. Referring to FIG. 1, the rechargeable lithium battery 100 is a cylindrical shape, and which mainly consisted of: a negative electrode 112; a positive electrode 114; a separator 113 existing between the negative electrode 112 and the positive electrode 114; an electrolyte (not shown) impregnated with the negative electrode 112, the positive electrode 114, and the separator 113; a battery container 120; and a sealing member 140 sealing the battery container 120. The rechargeable lithium battery 100 is constituted by sequentially stacking the negative electrode 112, the separator 113, and the positive electrode 114, and then stored in the battery container 120 under the spiral-wound shape.

The negative electrode includes a current collector and a negative electrode active material layer formed on the current collector, and the negative electrode active material layer includes a negative electrode active material.

The negative electrode active material is the same as previously stated above.

The negative electrode active material layer includes a binder, and may further optionally include a conductive material.

The binder may serve to attach the negative electrode active material particles to each other and attach the negative electrode active material to the current collector. As a typical example, polyvinyl alcohol, carboxy methyl cellulose, hydroxypropyl cellulose, polyvinyl chloride, carboxylated polyvinyl chloride, polyvinyl fluoride, a polymer containing ethylene oxide, polyvinyl pyrrolidone, polyurethane, polytetrafluoroethylene, polyvinylidene fluoride, polyethylene, polypropylene, styrene-butadiene rubber, acrylated styrene-butadiene rubber, epoxy resin, nylon, or the like may be used, but is not limited thereto.

The conductive material is used in order to give conductivity to the electrode, and may be any material as long as the electronic conductive material does not trigger a chemical change in the battery configured according to the method. For example, a conductive material may contain a carbon-based material such as natural graphite, artificial graphite, carbon black, acetylene black, ketjen black, carbon fiber, or the like; a metal-based material such as a metal power - copper, nickel, aluminum, silver, or the like, and a metal fiber or the like; a conductive polymer such as polyphenylene derivatives or the like; or a mixture thereof.

As the current collector, a copper thin film, a nickel thin film, a stainless steel thin film, a titanium thin film, a nickel foam, a copper foam, a polymer basic material coated with a conductive metal, or a combination thereof may be used.

The positive electrode includes the current collector and the positive electrode active material layer formed on the current collector.

As the positive electrode active material, a compound (lithiated intercalation compound) capable of reversibly intercalating and de-intercalating lithium may be used. In detail, the positive electrode active material may be at least one composite oxide formed of a metal such as cobalt, manganese, nickel, or a combination thereof and the lithium, and for specific example, any one of the compound represented by the following chemical formula may be used. LiₐA_{1-b}R_{b}D₂(wherein, 0.90≦a≦1.8 and 0≦b≦0.5); LiₐE_{1-b}R_{b}O_{2-c}D_{c}(wherein, 0.90≦a≦1.8, 0≦b≦0.5, and 0≦c≦0.05); LiE_{2-b}R_{b}O_{4-c}D_{c}(wherein, 0≦b≦0.5, 0≦c≦0.05); LiₐNi_{1-b-c}Co_{b}R_{c}D_{α} (wherein, 0.90≦a≦1.8, 0≦b≦0.5, 0≦c≦0.05 and 0<α≦2); LiₐNi_{1-b-c}Co_{b}R_{c}O_{2-α}Z_{α} (wherein, 0.90≦a≦1.8, 0≦b≦0.5, 0≦c≦0.05 and 0<α<2); LiₐNi_{1-b-c}Co_{b}R_{c}O_{2-α}Z₂ (wherein, 0.90≦a≦1.8, 0≦b≦0.5, 0≦c≦0.05 and 0<α<2); LiₐNi_{1-b-c}Mn_{b}R_{c}D_{α} (wherein, 0.90≦a≦1.8, 0≦b≦0.5, 0≦c≦0.05 and 0<α≦2); LiₐNi_{1-b-c}Mn_{b}R_{c}O_{2-α}Z_{α} (wherein, 0.90≦a≦1.8, 0≦b≦0.5, 0≦c≦0.05 and 0<α<2); LiₐNi_{1-b-c}Mn_{b}R_{c}O_{2-α}Z₂(wherein, 0.90≦a≦1.8, 0≦b≦0.5, 0≦c≦0.05 and 0<α<2); LiₐNi_{b}E_{c}G_{d}O₂ (wherein, 0.90≦a≦1.8, 0≦b≦0.9, 0≦c≦0.5 and 0.001≦d≦0.1); LiₐNi_{b}Co_{c}Mn_{d}GeO₂ (wherein, 0.90≦a≦1.8, 0≦b≦0.9, 0≦c≦0.5, 0≦d≦0.5 and 0.001≦e≦0.1); LiₐNiG_{b}O₂ (wherein, 0.90≦a≦1.8 and 0.001≦b≦0.1); LiₐCoG_{b}O₂ (wherein, 0.90≦a≦1.8 and 0.001≦b≦0.1); LiₐMnG_{b}O₂ (wherein, 0.90≦a≦1.8 and 0.001≦b≦0.1); LiₐMn₂G_{b}O₄ (wherein, 0.90≦a≦1.8 and 0.001≦b≦0.1); QO₂; QS₂; LiQS₂; V₂O₅; LiV₂O₅; LiTO₂; LiNiVO₄; Li_{(3-f)}J₂(PO₄)₃(0≦f≦2); Li_{(3-f)}Fe₂(PO₄)₃(0≦f≦2); and LiFeO₄.

In the above formula, A is Ni, Co, Mn or a combination thereof; R is Al, Ni, Co, Mn, Cr, Fe, Mg, Sr, V, a rare-earth element or a combination thereof; D is O, F, S, P or a combination thereof; E is Co, Mn or a combination thereof; Z is F, S, P or a combination thereof; G is Al, Cr, Mn, Fe, Mg, La, Ce, Sr, V or a combination thereof; Q is Ti, Mo, Mn or a combination thereof; T is Cr, V, Fe, Sc, Y or a combination thereof; J is V, Cr, Mn, Co, Ni, Cu or a combination thereof.

The compound having a coating layer on the surface may also be used, or the compound stated above and the compound having a coating layer may be used by mixing. As a compound of coated element, the coating layer may include oxide or hydroxide of the coated element, oxyhydroxide of the coated element, oxycarbonate of the coated element, or hydroxycarbonate of the coated element. The compound constituting the coating layer may be amorphous or crystalline. The coated element contained in the coating layer includes Mg, Al, Co, K, Na, Ca, Si, Ti, V, Sn, Ge, Ga, B, As, Zr or mixture thereof. A process of the formation of the coating layer may be any method of coating if the coating can be available by a method that does not adversely affect a physical properties of the positive electrode active material (e.g., spray coating, dipping, etc.). The method as described above is well-known to those skilled in the art. Thus, a detailed description thereof in the specification will be omitted.

The positive electrode active material layer also includes a binder and conductive material.

The binder may serve to attach the positive electrode active material particles to each other and attach the positive electrode active material to the current collector. As a typical example, polyvinyl alcohol, carboxy methyl cellulose, hydroxypropyl cellulose, diacetyl cellulose, polyvinyl chloride, carboxylated polyvinyl chloride, polyviny fluoride, a polymer containing ethylene oxide, polyvinyl pyrrolidone, polyurethane, polytetrafluoroethylene, polyvinylidene fluoride, polyethylene, polypropylene, styrene-butadiene rubber, acrylated styrene-butadiene rubber, epoxy resin, nylon, or the like may be used, but is not limited thereto.

The conductive material is used in order to give conductivity to the electrode, and may be any material as long as the electronic conductive material does not trigger a chemical change in the battery configured according to the method. For example, the metal powder, the metal fiber, or the like such as natural graphite, artificial graphite, carbon black, acetylene black, ketjen black, carbon fiber, copper, nickel, aluminum, silver, or the like may be used. In addition, a mixture of one or more conductive materials such as polyphenylene derivatives or the like may be used.

As the current collector, the aluminum (AL) may be used, but the current collector is not limited thereto.

The active material composition is prepared by mixing the active material, the conductive material, and the binding agent with a solvent, and each of the negative electrode and the positive electrode is prepared by applying the composition to the current collector. The method for preparing the electrode as described above is well-known to those skilled in the art. Therefore, a detailed description thereof in the specification will be omitted. As the solvent, N-methylpyrrolidone or the like may be used, but the solvent is not limited thereto.

The electrolyte may include a non-aqueous organic solvent and a lithium salt.

The non-aqueous organic solvent serves as a medium capable of moving the ions concerned in the electrochemical reaction of the battery.

As the non-aqueous organic solvent, a carbonate, an ester, an ether, a ketone, an alcohol, or an aprotic solvent may be used. As the carbonate-based solvent, dimethyl carbonate (DMC), diethyl carbonate (DEC), dipropyl carbonate (DPC), methylpropyl carbonate (MPG), ethylpropyl carbonate (EPC), methylethyl carbonate (MEC), ethylene carbonate (EC), propylene carbonate (PC), butylene carbonate (BC) and the like may be used. Moreover, the ester-based solvent includes methyl acetate, ethyl acetate, n-propyl acetate, 1,1-dimethyl-ethyl acetate, methyl propionate, ethyl propionate, γ-butyrolactone, decanolide, valerolactone, mevalonolactone, caprolactone, and the like may be used. As the ether-based solvent, Dibutyl ether, tetra-glyme, diglyme, dimethoxyethane, 2-methyl tetrahydrofuran, tetrahydrofuran and the like can be used. The ketone-based solvent includes cyclohexanone and the like may be used. The alcohol-based solvent includes ethyl alcohol, isopropyl alcohol and the like may be used. In addition, as the aprotic solvent, nitriles such as R—CN (R is a C2 to C20 hydrocarbon group whose structure is straight shape, branched shape or cyclic, and it may include a double bond in the aromatic cyclic or an ether bond), amides such as dimethylformamide, dioxolanes such as 1,3-dioxolane, sulfolanes and the like can be used.

The non-aqueous organic solvent may use alone, or in a combination of one or more solvents, and a mixing ratio of the solvent in the case in which the mixture of the one or more solvents is used may be appropriately adjusted according to the desired battery performance. The configuration will be widely understood by those skilled in the art.

In addition, in case of the carbonate-based solvent, mixing between cyclic carbonate and chain carbonate is preferably used. In this case, the recommended mixed volume ratio between the cyclic carbonate and the chain carbonate is about 1:1 to about 1:9 for excellent performance of the electrolyte.

The non-aqueous organic solvent may further include the aromatic hydrocarbon-based organic solvent on the carbonate-based solvent. In this case, the carbonate-based solvent and the aromatic hydrocarbon-based organic solvent may be mixed at a volume ratio of about 1:1 to about 30:1.

As the aromatic hydrocarbon-based organic solvent, a compound of aromatic hydrocarbon-based represented by the following chemical formula 1 may be used.

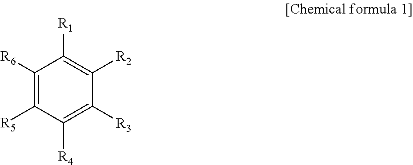

In the chemical formula 1, R₁ to R₆ are each independently hydrogen, halogen, C1 to C10 alkyl, C1 to C10 haloalkyl, or a combination thereof.

As the aromatic hydrocarbon-based organic solvent, Benzene, fluorobenzene, 1,2-difluorobenzene, 1,3-difluorobenzene, 1,4-difluorobenzene, 1,2,3-trifluorobenzene, 1,2,4-trifluorobenzene, chlorobenzene, 1,2-dichlorobenzene, 1,3-dichlorobenzene, 1,4-dichlorobenzene, 1,2,3-trichlorobenzene, 1,2,4-trichlorobenzene, iodobenzene, 1,2-diiodobenzene, 1,3-diiodobenzene, 1,4-diiodobenzene, 1,2,3-triiodobenzene, 1,2,4-triiodobenzene, toluene, fluorotoluene, 1,2-difluorotoluene, 1,3-difluorotoluene, 1,4-difluorotoluene, 1,2,3-trifluorotoluene, 1,2,4-trifluorotoluene, chlorotoluene, 1,2-dichlorotoluene, 1,3-dichlorotoluene, 1,4-dichlorotoluene, 1,2,3-trichlorotoluene, 1,2,4-trichlorotoluene, iodotoluene, 1,2-diiodotoluene, 1,3-diiodotoluene, 1,4-diiodotoluene, 1,2,3-triiodotoluene, 1,2,4-triiodotoluene, xylene, or a combination thereof may be used.

The non-aqueous electrolyte may further include vinylene carbonate or ethylene carbonate-based compound of the following chemical formula 2 in order to improve the cycle-life of the battery.

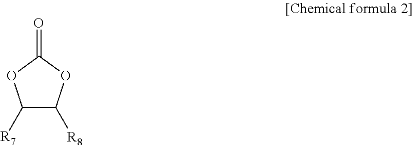

In the chemical formula 2, R₇ to R₈ are each independently hydrogen, halogen, cyano (CN), nitro (NO₂), or Cl to C5 fluoroalkyl, and at least one of R₇ and R₈ is halogen, cyano (CN), nitro (NO₂), or C1 to C5 fluoroalkyl.

The typical example of the ethylene carbonate-based compound is difluoroethylene carbonate, chloroethylene carbonate, dichloroethylene carbonate, bromoethylene carbonate, dibromoethylene carbonate, nitroethylene carbonate, cyanoethylene carbonate, fluoroethylene carbonate, or the like. In case of further using the vinylene carbonate or the ethylene carbonate-based compound, the cycle life may be improved by appropriate adjustment of the amount used.

The lithium salt dissolves in the non-aqueous organic solvent, so it is possible to operate the basic rechargeable lithium battery by it applying as the lithium ion source within the battery. The lithium salt serves to promote the movement of the lithium ions between the positive electrode and the negative electrode. The lithium salt may include LiPF₆, LiBF₄, LiSbF₆, LiAsF₆, LiC₄F₉SO₃, LiClO₄, LiAlO₂, LiAlCl₄, LiN (CₓF₂ₓ₊₁SO₂) (C_{y}F_{2y+1}SO₂) (herein, x and y are natural numbers), LiCl, LiI, LiB (C₂O₄)₂ (lithium bis (oxalato) borate; LiBOB), or combination thereof, as a supporting electrolytic salt. The concentration of the lithium salt is preferably used in the range 0.1 to 2.0 M. If the concentration of the lithium salt is included in the range stated above, the electrolyte has excellent performance due to its proper conductivity and viscosity. Thus, the lithium ions can be moved efficiently.

The separator 113 serves to electrically isolate the negative electrode 112 and the positive electrode 114 from each other and provide a moving path for the lithium ions. Any separator may be used as long as it is generally used in a lithium battery. That is, a separator having excellent wetting performance while having a low resistance to ion movement of the electrolyte may be used. For example, the separator may be any one selected from a glass fiber, polyester, Teflon, polyethylene, polypropylene, polytetrafluoroethylene (PTFE), and combinations thereof, and may also be a non-woven or woven fabric type. For example, a polyolefin polymer separator such as polyethylene, polypropylene, or the like is mainly used in the lithium ion battery. Further, a separator coated with a ceramic component or a polymer material in order to secure mechanical strength or heat resistance may be used optionally used in a single-layer or multi-layer structure.

Hereinafter, examples and comparative examples of the present invention will be described. However, this is only one example of the present invention and the present invention is not limited thereto.

### EXAMPLE

### Example 1

Highly crystalline natural graphite is prepared by heat-treatment of a spherical natural graphite whose average particle size is 16 μm in the Rotary Kiln, box furnace, or fluidizing bed furnace under conditions of an air atmosphere, 600° C., and 8 hours. Molded body is obtained by an isostatic press (e.g., Cold Isostatic Press, CIP equipment) of the prepared highly crystalline natural graphite. Graphite powder is obtained by deagglomerating the molded body through the ACM (Air Classifier Mill), pin mill, or cyclone mill, etc. Natural graphite negative electrode active material is prepared by classification of the graphite powder using 45 μm network.

Cold isostatic press: KOBELCO CIP Equipment [KOBELCO (CP1300)]

The condition of the press: 100 MPa, 5 minutes

In the example 1, the measurement results of the physical property of the highly crystalline natural graphite indicate that its average diameter is 16 μm, tap density is 1.0 g/cm³, specific surface area is 4.5 m²/g, Raman R value is 0.05, and porosity is 0.10 ml/g.

The prepared negative electrode active material of the example 1, styrene-butadiene rubber (SBR) as a binder, and carboxymethyl cellulose (CMC) as a thickener are mixed at a mass ratio of 98:1:1, and then dispersed in distilled water with ions removed to prepare the negative electrode active material layer composition. Then, the negative electrode having electrode density of 1.60+0.05 g/cm³ is prepared by coating, drying, and pressing the composition.

A positive electrode pole plate is prepared by mixing LiCoO₂ 95.5%, 1.5% of acetylene black and PVDF 3%. A rechargeable lithium battery (Full-cell) is prepared by putting a polypropylene separator into a battery container between a negative electrode and a positive electrode, and by injecting an electrolyte.

A half-cell battery for measuring the initial efficiency is the same except for using the lithium metal as the counter electrode.

Preparation of 2032-type battery

Electrolyte (EC: DEC=3:7 LiPF6 1M)

### Comparative Example 1

Highly crystalline natural graphite is prepared by heat treatment of a spherical natural graphite whose average particle size is 16 μm in the Rotary Kiln, box furnace, or fluidizing bed furnace under conditions of an air atmosphere, 600° C., and 8 hours. Natural graphite negative electrode active material is prepared by classification using 45 μm network of the graphite powder obtained by method stated above.

In the comparative example 1, the measurement results of the physical property of the highly crystalline natural graphite indicate that its average diameter is 16 μm, tap density is 0.84 g/cm³, specific surface area is 4.8 m²/g, Raman R value is 0.05, and porosity is 0.20 ml/g.

The electrode pole plate having electrode density of 1.60+0.05 g/cm³ is prepared by using the natural graphite negative electrode active material. The preparation process of full cell is the same as in Example 1.

### Comparative Example 2

Molded body is obtained by an isostatic press (Cold Isostatic Press) of the highly crystalline natural graphite whose average particle size is 16 μm. Graphite powder is obtained by deagglomerating the molded body through the ACM (Air Classifier Mill), pin mill, or cyclone mill, etc. Natural graphite negative electrode active material is prepared by classification of the graphite powder using 45 μm network.

In the comparative example 2, the measurement results of the physical property of the highly crystalline natural graphite indicate that its average diameter is 16 μm, tap density is 1.03 g/cm³, specific surface area is 5.2 m²/g, Raman R value is 0.20, and porosity is 0.11 ml/g.

The electrode pole plate having electrode density of 1.60±0.05 g/cm³ is prepared by using the natural graphite negative electrode active material. The preparation process of full cell is the same as in Example 1.

### Comparative Example 3

Mixing the spherical natural graphite particle having an average particle size of 16 μm and the binder pitch having a softening point of 250° C. at a weight ratio of 100:4 (natural graphite: binder pich), and homogeneously mixing on the high-speed stirrer at a speed of 2,200 rpm for 10 minutes.

The temperature of mixture is elevated from room temperature to 1300° C. for 3 hours in an electric furnace, and then the firing is done by keeping it at 1300° C. for 1.5 hours.

Natural graphite negative active material is prepared by the classification using 45 μm network of the graphite composite obtained by the method stated above.

In the example 3, the measurement results of the physical property of the spherical natural graphite indicate that its average diameter is 16 μm, tap density is 1.04 g/cm³, specific surface area is 2.9 m²/g, Raman R value is 0.35, and porosity is 0.13 ml/g.

The electrode pole plate having electrode density of 1.60±0.05 g/cm³ is prepared by using the natural graphite negative electrode active material. The preparation process of full cell is the same as in Example 1.

### EXPERIMENTAL EXAMPLE

TABLE 1

| | | Comparative | Comparative | Comparative |
|---|---|---|---|---|
| | Example 1 | Example 1 | Example 2 | Example 3 |
| Specific | 4.5 | 4.8 | 5.2 | 2.9 |
| surface area | | | | |
| (m²/g) | | | | |
| Porosity | 0.10 | 0.20 | 0.11 | 0.13 |
| (ml/g) | | | | |
| Tap density | 1.00 | 0.84 | 1.03 | 1.04 |
| (g/cm³) | | | | |
| Raman R value | 0.05 | 0.05 | 0.20 | 0.35 |
| (Id/Ig) | | | | |
| Initial | 94.6 | 93.8 | 92.1 | 93.0 |
| efficiency | | | | |
| rate (%) | | | | |
| Charge and | 80 | 77 | 50 | 12 |
| discharge | | | | |
| capacity of | | | | |
| 500 times | | | | |
| Retention | | | | |
| rate (%) | | | | |
| Thickness | 28 | 36 | 55 | 74 |
| growth rate | | | | |
| after 500 | | | | |
| times (%) | | | | |

### Evaluation 1: Measurement of Specific Surface Area

The specific surface area of the negative electrode active material may be measured through equipment such as Micromeritics' TriSta or Quantachrome's Autosorb-6B.

The measurement result of specific surface area is shown in Table 1. As can be seen in Table 1, the Example 1 of the present invention in comparison with comparative Example 1 indicates that the specific surface area is decreased through the isostatic pressing process.

### Evaluation 2: Measurement of Porosity

The pore volume may be measured through Mercury Porosimetry (Micromeritics' AutoPore IV 9505) using the principle of measuring the porosity based on mercury penetrate. It may be measured the porosity of less than 2000 nm.

The measurement result of porosity is shown in Table 1. As can be seen in Table 1, it may be confirmed that the porosity of the active material of the Example 1 is very low. From this, it may confirmed that the internal porosity of the highly crystalline natural graphite is greatly decreased. In addition, as the graphite becomes high density, the tap density is increased and the solution injection on the high density electrode plate is improved. Moreover, the volume expansion in the course of the development cycle can be suppressed by blocking the swelling of the graphite particle resulted from the growth of the oxide film in the internal pores.

### Evaluation 3: Measurement of Tap Density

The tap density of the negative electrode active material may be measured through the tap density meter (Quantachrome's Autotap) after the tapping 3,000 times.

The measurement result of tap density is shown in Table 1. As can be seen in Table 1, the increased tap density resulted from removing the internal pores as the method of the Example 1 can be found.

### Evaluation 4: Measurement of Raman R Value

The Raman R value representing the degree of crystallization of the negative electrode active material may be measured through the Raman spectroscopy equipment such as Horiba Jobin-Yvon's LabRam HR (High Resolution). The evaluation condition of Raman is as follows.

Laser 514.532 nm (Ar-ion laser) Power=0.5 mW @ sample

Time=30 sec

Accumulation=1 objective×50 (0.84 μm)

Hole 1000 slit=100

The measurement result of Raman R value is shown in Table 1.

As noted above, the Raman R value means that the intensity ratio R (R=Id/Ig) measured by the intensity Ig of peak Pg near the 1580 cm⁻¹ and the intensity Id of peak Pd near the 1360 cm⁻¹ in the Raman spectrum analysis.

The Raman R value of Table 1 indicates that the Example 1 of the present invention has a highly crystalline characteristic.

### Evaluation 5: Evaluation on the Battery Characteristic

The initial efficiency and charge and discharge capacity retention rate are measured though each prepared Half-cell and Full cell according to Example 1 and Comparative Example 1 to 3.

The measurement condition of initial efficiency is set to 0.01 V and 0.01 C rate current as charging cut-off condition in the CC-CV mode. By charging as 0.1 C rate and then discharging to 1.5 V as 0.1 C rate in CC mode, the charge and discharge capacity is measured individually.

The measurement condition of charge-discharge cycle is set to 4.2 V and 0.1 C rate current as charging cut-off condition in the CC-CV mode. After repeating 500 times cycles, charging as 1.0 C rate and then discharging to 1.5 V as 0.1 C rate in the CC mode, the retention capacity rate is measured.

In Examples of the present invention, great improvements in initial efficiency and cycle life characteristics can be seen.

### Evaluation 6: Evaluation on the Plate Thickness Change Rate

The plate thickness growth rate is measured according to before and after 500 times charge-discharge cycles of Evaluation 5. The result is shown in Table 1.

It can be seen that the volume expansion of the negative electrode of Example 1 of the present invention is the smallest, and which is considered that it give an effect on the improvement of the cycle life characteristic. In addition, it inhibits the battery transformation resulted from the volume expansion of the negative electrode during the long-term use of a battery.

The present invention is not limited to the exemplary embodiments, but may be implemented in various different forms. It may be understood by those skilled in the art to which the present invention pertains that the present invention may be implemented with other specific forms without changing the spirit or essential features thereof. Therefore, it should be understood that the above-mentioned embodiments are not restrictive but are exemplary in all aspects.

<Description of Symbols>

| | |
|---|---|
| 100: rechargeable lithium battery | 112: negative electrode |
| 113: separator | 114: positive electrode |
| 120: vessel | 140: sealing member |

What is claimed is:

1. A negative electrode active material for a rechargeable lithium battery, comprising:
a highly crystalline spherical natural graphite,
wherein a Raman R value is 0.03 or more and 0.15 or less, and
an internal porosity (m-?/g) is 0.15 or less.
(The Raman R value means that the intensity ratio R (R=Id/Ig) measured by the intensity Ig of peak Pg near the 1580 cm⁻¹ and the intensity Id of peak Pd near the 1360 cm⁻¹ in the Raman spectrum analysis.)

2. The negative electrode active material for a rechargeable lithium battery of claim 1, wherein
the highly crystalline spherical natural graphite is an oxidized form of a spherical natural graphite.

3. The negative electrode active material for a rechargeable lithium battery of claim 1, wherein
the highly crystalline spherical natural graphite is a form reduced internal pore by an isostatic press.

4. The negative electrode active material for a rechargeable lithium battery of claim 1, wherein
a tap density (g/cm³) of the highly crystalline spherical natural graphite is 1.0 or more and 1.5 or less.

5. The negative electrode active material for a rechargeable lithium battery of claim 1, wherein
an average particle size of the highly crystalline spherical natural graphite is 5 to 30 μm.

6. A method for preparing a negative electrode active material for a rechargeable lithium battery, comprising:
preparing a natural graphite;
obtaining a highly crystalline natural graphite by heat treatment of the natural graphite;
densifying the highly crystalline natural graphite by a isostatic press;
grinding the densified highly crystalline natural graphite.

7. The method of claim 6, wherein
the obtaining a highly crystalline natural graphite by heat-treatment of the natural graphite is
performed at a temperature of 400 to 700° C.

8. The method of claim 7, wherein
the obtaining a highly crystalline natural graphite by heat-treatment of the natural graphite is
performed in an oxidizing condition of a gas or solid phase including an oxygen or a material capable of oxidation of graphite.

9. The method of claim 6, wherein
the densifying the highly crystalline natural graphite by an isostatic press is
performed at a pressure 50 MPa or more.

10. The method of claim 6, wherein
a Raman R value of the prepared negative electrode active material is 0.03 or more and 0.15 or less, and
an internal porosity (ml/g) thereof is 0.15 or less.
(The Raman R value means that the intensity ratio R (R=Id/Ig) measured by the intensity Ig of peak Pg near the 1580 cm⁻¹ and the intensity Id of peak Pd near the 1360 cm⁻¹ in the Raman spectrum analysis.)

11. The method of claim 6, wherein
a tap density (g/cm³) of the prepared negative electrode active material is 1.0 or more and 1.5 or less.

12. The method of claim 6, wherein
an average particle size of the prepared negative electrode active material is 5 to 30 μm.

13. A rechargeable lithium battery comprising: a negative electrode containing the negative electrode active material for a rechargeable lithium battery of claim 1;
a positive electrode; and
an electrolyte.
